(19) United States
(12) Patent Application Publication
(10) Pub. No.: US 2007/0287638 A1
(43) Pub. Date: Dec. 13, 2007

(54) Use of dicarbonyl compounds for increasing the thermal stability of biopolymers in the field of oil and gas exploration

(76) Inventors: Johann Plank, Trostberg (DE); Gregor Keilhofer, Tacherting (DE); Peter Lange, Obing (DE)

Correspondence Address: FULBRIGHT & JAWORSKI, LLP, 666 FIFTH AVE, NEW YORK, NY, 10103-3198, US

(21) Appl. No.: 11/590,659

(22) Filed: Oct. 30, 2006

(30) Foreign Application Priority Data
Jun. 9, 2006 (DE) 10 2006 029 265.0

(51) Int. Cl. C09K 8/68

(52) U.S. Cl. 507/209

(57) ABSTRACT

The use of dicarbonyl compounds for increasing the thermal stability of biopolymers in aqueous liquid phases in petroleum and natural gas exploration is claimed. The biopolymer component preferably comprises polysaccharides prepared by fermentation, such as, for example, scleroglucan or welan gum. The aqueous liquid phase is typically a drilling fluid which may also contain high salt concentrations (“brines”). Glyoxal may be mentioned as a particularly suitable member of the dicarbonyls. It can either be admixed with the liquid phase or preferably also be incorporated in the course of the preparation of the biopolymer. The use according to the invention shows their advantages, particularly at temperatures in the rock formation which are above 250° Fahrenheit.

### BACKGROUND AND SUMMARY OF THE INVENTION

This application claims priority from German priority application no. 10 2006 029 265.0 filed Jun. 9, 2006, incorporated herein by reference in its entirety.

The present invention relates to the use of dicarbonyl compounds for increasing the thermal stability of biopolymers in aqueous liquid phases employed in the field of oil and gas exploration.

Biopolymers, in particular those of fermentative origin, such as, for example, scleroglucan, xanthan gum, succinoglycan, diutan or welan gum, are widely used for viscosity formation in aqueous liquid phases; for example, in cosmetic products or generally in the food industry. Regardless of the various fields of use, the shear-thinning and/or thixotropic thickening of the respective liquid phase is frequently of primary importance.

Among the industrial applications of biopolymers, rheology control of drilling fluids used for exploring natural oil and gas reserves should be mentioned in the first place. It is known to the person skilled in the art that particularly shear-thinning drilling fluids promote the removal of drill cuttings from the borehole in a very efficient manner. In detail, the biopolymers play a different role in the different drilling applications: in addition to said improvement of the carrying capacity in combination with good pumpability, biopolymer-based shear-thinning fluids also reduce the fluid loss, stabilize soil formations and promote easy separation of the cuttings from the drilling fluid circulation.

In practice, biopolymers are particularly frequently used as thickeners for solids-free drilling fluids, so-called “drill-in fluids”. In contrast to aqueous clay suspensions, biopolymer-based “drill-in fluids” avoid damage to the reservoir formation, resulting finally in a higher productivity of the oil or gas well. Furthermore, biopolymers are frequently an essential constituent of so-called “spacer fluids”, which are used in the run-up to well cementing in order to ensure optimum binding of the cement to the borehole wall.

In accordance with this broad range of applications, “aqueous liquid phases” are understood in the present context also as meaning those which, in addition to fresh water or sea water, may contain a number of further main or secondary components; this also includes salt-containing systems (so-called “brines”) and more complex drilling fluids, such as, for example, emulsions or invert emulsions, which may also contain large proportions of an oil component.

According to the prior art to date, only certain biopolymers are suitable for common high-temperature applications in the region of ≧250° F. which are entirely customary in oil and gas exploration. Scleroglucan and welan gum may be primarily mentioned here. In comparison to xanthan gum, these special polysaccharides have, as a rule, a substantially higher thermal stability which, depending on the conditions of use, is usually 50 to 100° F. above the limit of xanthan gum. In addition, the comparatively cheap xanthan gum generally declines dramatically in rheological performance even at temperatures substantially below 250° F. (in general from 160° F.). Even before thermal degradation of the xanthan gum molecules occurs, the structural viscosity is “spontaneously” reduced thereby as a result of Brownian molecular movement.

In principle, the degradation of the biopolymer chains and their viscosifying properties takes place in the course of time and as a function of the temperature profile, in the course of drilling. The exact composition of the liquid phase is also of importance. Thus, it is known that high salt contents enhance the detrimental effect whereas small doses of certain salts have a limited stabilizing influence. Such so-called “oxygen scavengers” or reducing agents, such as, for example, sodium sulfite, sodium bisulfite or formate salts, are frequently used in practice. Furthermore, it is known that so-called redox catalysts or free radical mediators, such as, for example Fe²⁺, Co²⁺ or Ni²⁺, promote the action of said “oxygen scavengers”. Presumably, their presence is even absolutely essential for the action mechanism of a redox reaction with dissolved oxygen.

The use of amines as “thermal extenders” for hydroxyethylcellulose (HEC) has already been described in WO 02/099258 A1, the use in combination with xanthan gum also being mentioned.

It remains to be stated that said stabilizers always have only gradual effects, which results in only a relative improvement depending on the biopolymer used. This means firstly that xanthan gum does not reach the level of the other stated biopolymers even in the presence of such stabilizers according to the prior art. Secondly, however, this also means that there are likewise upper temperatures limits for these “relatively high-quality” biopolymers, such as scleroglucan and welan gum.

This is to be seen alongside the trend for drilling increasingly deeply for oil or gas, so that the drilling fluid used has to withstand increasingly high temperatures.

It was therefore the object of the present invention to provide novel compounds for increasing the thermal stability of biopolymers in aqueous liquid phases in petroleum and natural gas exploration. Each increase in the upper temperature limit and an associated extension of the possible range of applications are to be regarded as substantial progress from the point of view of the person skilled in the art.

This object was achieved by the use of dicarbonyl compounds.

Surprisingly, it was found that dicarbonyl compounds are capable of increasing the thermal stability of biopolymers. Thus, a marked effect is achieved even with the simple binary mixture of, for example, scleroglucan and a dialdehyde. In particular, however, an extension of the upper temperature limit is achieved by combination with a known stabilizer, such as, for example, sodium bisulfite. This effect of the dicarbonyls is all the more surprising since, owing to their chemical structure and possible reactions, these compounds are not to be assigned to the known category of the reducing agents or “oxygen scavengers” and also do not act as pH buffers in the sense of the abovementioned amines. It is to be assumed that dicarbonyls generally and glyoxal in particular form acetals and hemiacetals with the ROH groups of the polysaccharide biopolymers. It is true that it is known that this leads to improved solubility of biopolymers; however, this does not result in a plausible starting point for a mechanistic explanation of the improved thermal stability, and it is for this reason that the claimed effect is all the more surprising.

### DETAILED DESCRIPTION

The biopolymer component according to the present invention should preferably be a polysaccharide prepared by fermentation, members of the series consisting of scleroglucan, welan gum, diutan, rhamzan and succinoglycan being regarded as being particularly suitable.

In connection with the oil and gas exploration applications essential to the invention, those aqueous liquid phases which constitute a drilling fluid are particularly suitable. The observed effect of the increase in the thermal stability is observed to be particularly pronounced in the case of dicarbonyls if this drilling fluid preferably contains fresh water and/or sea water. Particularly preferably, it should be a salt-containing system of the “brine” type. However, the present invention also includes a variant in which the drilling fluid is an oil-containing emulsion or an invert emulsion.

From the series of the suitable dicarbonyl components which effect the increase in the thermal stability of biopolymers, dialdehydes, such as malonaldehyde CH₂(CHO)₂, succinaldehyde C₂H₄(CHO)₂, glutaraldehyde C₃H₆(CHO)₂ and preferably the simplest member, glyoxal CHOCHO, have proved to be particularly suitable. Furthermore, certain diketones, such as, for example, dimethylglyoxal (COCH₃)₂ or acetylacetone CH₂(COCH₃)₂, are also claimed as typical members of the dicarbonyls in the context of this invention. However, dicarboxylic acids and their derivatives, namely salts, esters and ethers, are also preferred dicarbonyl components. Overall, it should be stated that compounds having vicinal carbonyl groups have proved to be particularly suitable. In addition to these α-dicarbonyl compounds, however, β-dicarbonyl compounds, such as, for example, malonic acid, also fulfil the purpose according to the invention.

The present invention also comprises that the dicarbonyl component is admixed with the liquid phases independently of its chemical composition, although a variant in which the dicarbonyl component is incorporated into the biopolymer in the course of the preparation of said biopolymer is being regarded as being particularly preferred.

The effect, according to the invention, of the dialdehyde component, namely the increase in the thermal stability, can be additionally increased by using, in addition to the dicarbonyl component, other compounds which serve for stabilizing the drilling fluid, in particular the biopolymers present therein, and especially for increasing the thermal stability thereof. From the series of the suitable compounds, in particular “oxygen scavengers”, such as, for example, lignosulfonates and tannates, may be mentioned at this point. Preferably, sodium sulfite, sodium bisulfite or formates, i.e. salts of formic acid, which are generally known as reducing agents (cf. “Composition and Properties of Drilling and Completion Fluids”, 5th Edition, Darley H. C. H. & Gray G. R., Gulf Publishing Company, Houston, Tex., Pages 480 to 482) are also suitable. However, primary, secondary and tertiary amines and in particular triethanolamine are suitable as well.

It should also be noted that the performance of said “oxygen scavengers” or radical scavengers, such as, for example, sodium sulfite, can additionally be markedly increased by Fe²⁺, Ni²⁺ or Co²⁺ salts. These salts presumably act as free radical mediators and thus catalyse the binding of free oxygen radicals.

The use according to the invention is in principle not bound to any defined temperature range, but the effect of thermal stability is particularly pronounced if the temperatures in the rock formation are >250° Fahrenheit, preferably >75° Fahrenheit and particularly preferably >300° Fahrenheit.

In summary, it remains to be stated that dicarbonyls are surprisingly excellently suitable for increasing the thermal stability of biopolymers in aqueous liquid phases which are used in oil and gas exploration. The success of the use according to the invention is therefore all the more unexpected since compounds having dicarbonyl features cannot be assigned to the classes of compounds known to date which are already known to increase the thermal stability of biopolymers markedly.

The following examples illustrate the advantages of the present invention.

### EXAMPLES

The properties of the respective drilling fluids were determined according to the methods of the American Petroleum Institute (API), guideline RP13B-1. Thus, the rheologies were measured using an appropriate FANN 35 viscometer at 600, 300, 200, 100, 6 and 3 revolutions per minutes [rpm]. As is known, the measurements at the slow speeds of 6 and 3 rpm are particularly relevant with regard to the structural viscosity and carrying capacity of the fluids. In addition to this, the so-called “low shear rheology” was also determined using a Brookfield HAT viscometer at 0.5 rpm. Specifically, the measurements were conducted in each case before and after a thermal treatment (“ageing”) over 16 hours in a roller oven customary in the industry, at the temperatures stated in each case.

### Example 1

The increase in the temperature stability of a salt-containing aqueous solution of scleroglucan by glyoxal is described. The scleroglucan component used was the BIOVIS® product from Degussa Construction Polymers GmbH (comparison); in the experiments according to the invention, the BIOVIS® product contained an amount of <1% of glyoxal (“+G”) in addition to scleroglucan.

### Preparation of the Drilling Fluids:

350 ml of an NaCl-saturated aqueous solution (109 g of NaCl and 311 g of water) were initially introduced into a Hamilton Beach Mixer (HBM) customary in the industry, at “low” speed. Thereafter, 3.5 g of the respective BIOVIS® component and 1 g of sodium sulfite (stabilizer) and 1 ml of tributyl phosphate (antifoam) were added. After stirring for 20 minutes in the HBM, the rheology was measured at a temperature of 140° F. (BHR=before hot roll). Further rheology measurements at 140° F. were effected after thermal loading over 16 hours at the ageing temperatures of 300 to 350° F. stated in each case (AHR=after hot roll).

### Results:

TABLE 1

| NaCl-saturated | | FANN 35 rheology | |
|---|---|---|---|
| Density 10 ppg | | (140° F.) | Brookfield HAT |
| (pounds per | | at 600-300-200-100-6-3 rpm | rheology at 0.5 rpm |
| gallon) | Measurement | [lbs/100 ft²] | [mPa · s] |
| BIOVIS ® | BHR | 31-21-19-15-9-7 | 23200 |
| BIOVIS ® + G | BHR | 49-36-32-26-14-13 | 49440 |
| BIOVIS ® | AHR @ 300° F. | 49-41-38-33-24-22 | 63120 |
| BIOVIS ® + G | AHR@ 300° F. | 56-49-45-39-27-24 | 68800 |
| BIOVIS ® | AHR @ 325° F. | 39-33-30-26-16-13 | 27360 |
| BIOVIS ® + G | AHR@ 325° F. | 62-50-45-38-26-24 | 74080 |
| BIOVIS ® | AHR @ 350° F. | 17-12-9-7-1-1 | 0 |
| BIOVIS ® + G | AHR@ 350° F. | 44-42-39-35-23-21 | 68320 |

Firstly, the data makes it clear that moderate temperatures up to 300° F. even improve the rheological performance of scleroglucan. However, this is purely a hydration effect in salt-saturated “brines”; i.e. the biopolymer goes completely into solution only under a thermal conditioning. This subsequent dissolution is less pronounced in the case of BIOVIS®+G (invention) since this glyoxal-containing type is very readily soluble from the beginning and at customary ambient temperatures.

Finally the further experimental series at demanding temperatures of 300 to 350° F. substantiates the improvement of the thermal stability by the presence of a glyoxal, which is found according to the invention.

### Example 2

The increase in the thermal stability of a calcium chloride-loaded, aqueous solution of scleroglucan by glyoxal is described. The scleroglucan component used was the BIOVIS® product from Degussa Construction Polymers GmbH (comparison); in the experiments according to the invention, the BIOVIS® product contained an amount of <1% of glyoxal (“+G”) in addition to scleroglucan.

### Preparation of the Drilling Fluids:

350 ml of a CaCl₂-containing aqueous solution (155 g of CaCl₂ and 307 g of water) were initially introduced into a Hamilton Beach Mixer (HBM) customary in the industry, at “low” speed. Thereafter, 3.5 g of the respective BIOVIS® component, 1 g of sodium sulfite (stabilizer), 0.25 g of Fe^{II}SO₄ as a free radical mediator and 1 ml of tributyl phosphate (antifoam) were added. After stirring for 20 minutes in the HBM, the rheology was measured at a temperature of 140° F. (BHR=before hot roll). Further rheology measurements at 140° F. were effected after thermal loading over 16 hours at the ageing temperatures of 300 to 350° F. stated in each case (AHR=after hot roll).

### Results:

TABLE 2

| CaCl₂ brine | | FANN 35 rheology | |
|---|---|---|---|
| Density 11 ppg | | (140° F.) | Brookfield HAT |
| (pounds per | | at 600-300-200-100-6-3 rpm | rheology at 0.5 rpm |
| gallon) | Measurement | [lbs/100 ft²] | [mPa · s] |
| BIOVIS ® | BHR | 54-41-35-30-19-17 | 44640 |
| BIOVIS ® + G | BHR | 52-39-35-29-20-17 | 48320 |
| BIOVIS ® | AHR @ 300° F. | 44-38-34-29-16-13 | 41120 |
| BIOVIS ® + G | AHR@ 300° F. | 48-40-37-32-21-18 | 46560 |
| BIOVIS ® | AHR @ 325° F. | 32-24-20-15-5-3 | 5000 |
| BIOVIS ® + G | AHR@ 325° F. | 45-39-37-32-20-17 | 46240 |
| BIOVIS ® | AHR @ 350° F. | 17-13-10-7-1-1 | 0 |
| BIOVIS ® + G | AHR@ 350° F. | 43-34-30-24-12-10 | 19480 |

Once again, the data, particularly at the very demanding temperatures above 300° F., substantiate the improvement in the thermal stability by the addition of glyoxal, which was found according to the invention.

### Example 3

Increasing the thermal stability of an aqueous solution of welan gum by addition of glyoxal is described. The welan gum component used was the product BIOZAN® from CP Kelco. Glyoxal was used in the form of a commercially available 40% aqueous solution. Furthermore, the fluid was contaminated by addition of a freshly prepared cement slurry in order to simulate the conditions of use as “spacer fluid”.

### Preparation of the Drilling Fluids:

350 ml of water were initially introduced into a Hamilton Beach Mixer (HBM) customary in the industry, at “low” speed. 3.5 g of BIOZAN® and 1.0 g of Na₂SO₃ (stabilizer) and 1 ml of tributyl phosphate (antifoam) were added. 0.35 ml of glyoxal solution was added to one of the two batches of this type which were prepared simultaneously (invention). Thereafter, in each case 50 g of a cement slurry (consisting of 800 g of class H cement from Lafarge and 304 g of water, stirred beforehand for 20 min in an atmospheric consistometer at 60° C.) were mixed in. After stirring for 20 minutes in the HBM, the rheology was measured at a temperature of 140° F. (BHR=before hot roll). Further rheology measurements were effected after thermal loading over 4 hours at 300° F. (AHR=after hot roll).

### Results:

TABLE 3

| Cement- | | FANN 35 rheology | |
|---|---|---|---|
| contaminated | | (140° F.) | Brookfield HAT |
| fluid with the | | at 600-300-200-100-6-3 rpm | rheology at 0.5 rpm |
| welan gum | Measurement | [lbs/100 ft²] | [mPa · s] |
| BIOZAN ® | BHR | 79-70-67-60-40-36 | 74000 |
| BIOZAN ® + 1% | BHR | 70-65-62-57-38-32 | 68000 |
| Glyoxal | | | |
| BIOZAN ® | AHR @ 300° F. | 44-35-33-28-11-8 | 7200 |
| BIOZAN ® + 1% | AHR@ 300° F. | 82-72-69-63-42-36 | 66000 |
| Glyoxal | | | |

Once again, the data substantiate the improvement of the thermal stability by the addition of glyoxal, which is found according to the invention.

1-9. (canceled)

10. A method comprising increasing the thermal stability of a biopolymer in an aqueous liquid phase in oil or gas exploration by adding a sufficient amount of a dicarbonyl compound to the aqueous liquid phase to increase the thermal stability of the biopolymer.

11. The method according to claim 10, wherein the biopolymer is a polysaccharide prepared by fermentation.

12. The method according to claim 10, wherein the aqueous liquid phase is a drilling fluid.

13. The method of claim 10, wherein the dicarbonyl compound is selected from the group consisting of a dialdehyde, a diketone a dicarboxylic acid and derivatives thereof.

14. The method of claim 10, wherein the dicarbonyl component is admixed with the liquid phase or is incorporated during preparation of the biopolymer.

15. The method according to claim 10, further comprising adding a stabilizer, or an oxygen scavenger.

16. The method according to claim 15, wherein the stabilizer is combined with at least one of a Fe²⁺, Ni²⁺ or a Co²⁺ salt.

17. The method according to claim 10, wherein the liquid phase comprises a drilling fluid, a completion brine, a drill-in fluid or a spacer fluid which further comprises at least one additional additive for controlling the rheology of the liquid phase, for filtrate reduction, for controlling the density, for cooling and lubricating the drill bit, for stabilizing the borehole wall or for chemical stabilization of the drilling fluid.

18. The method of claim 10, wherein the biopolyler component is selected from the group consisting of scleroglucan, welan gum, diutan, rhamzan and succinoglycan.

19. The method according to claim 10, wherein the aqueous liquid phase comprising at least one of fresh water or salt water.

20. The method of claim 10, wherein the aqueous liquid phase is a salt-containing system that is a brine, an oil-containing emulsion or an invert emulsion.

21. The method of claim 20, wherein said derivative is a salt ester or ether.

22. The method of claim 10, wherein said dicarbonyl compound is selected from the group consisting of malonaldehyde, succinaldehyde, glutaraldehyde and glycoxal.

23. The method of claim 14, wherein said dicarbonyl compound is glyoxal.

24. The method of claim 15, wherein the stabilizer is selected from the group consisting of a lignosulfonate, a tannate, sodium sulfite, sodium bisulfite, a formate, a primary amine, a secondary amine, a tertiary amine.

25. The method of claim 15, wherein said stabilizer is triethanolamine.

26. The method of claim 10, conducted at a temperature of at least 275° F.

27. The method of claim 10, conducted at a temperature of at least 300° F.
